(19) United States
(12) Patent Application Publication
(10) Pub. No.: US 2018/0301239 A1
(43) Pub. Date: Oct. 18, 2018

(54) INSULATED WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Satoshi MURAO, Yokkaichi-shi, Mie (JP); Hayato OOI, Yokkaichi-shi, Mie (JP); Toyoki FURUKAWA, Yokkaichi-shi, Mie (JP); Hiroshi HAYAMI, Osaka-shi, Osaka (JP); Kenji HORI, Kanuma-shi, Tochigi (JP)

(21) Appl. No.: 15/768,639

(22) PCT Filed: Mar. 15, 2017
(86) PCT No.: PCT/JP2017/010472

§ 371 Date: Apr. 16, 2018

(30) Foreign Application Priority Data
Mar. 31, 2016 (JP) 2016-071149

(51) Int. Cl. H01B 7/02; H01B 7/282; H01B 3/30; H01B 3/28; H01B 3/44

(52) U.S. Cl. CPC H01B 7/02; H01B 7/282; H01B 3/445; H01B 3/28; H01B 3/301

(57) ABSTRACT

An insulated wire in which fatigue of the insulated wire can be restrained even when the insulated wire is disposed in an automatic transmission or a continuously variable transmission, and is shaken by AT fluid or CVT fluid. The insulated wire includes a conductor and an insulator that covers an outer circumference of the conductor. The cross-sectional area of the conductor is 0.4 mm² or less. The insulator contains a polymer having S or F in a main chain, and has a thickness of 0.05 mm or more. The density of the insulated wire is 3.1 g/cm³ or more. The density of the insulator is preferably 1.5 g/cm³ or more.

### CROSS REFERENCE TO RELATED APPLICATIONS

This application claims the priority of Japanese patent application JP2016-071149 filed on Mar. 31, 2016, the entire contents of which are incorporated herein.

### TECHNICAL FIELD

The present invention relates to an insulated wire.

### BACKGROUND ART

As a conventional insulated wire to be routed in AT (an automatic transmission) or CVT (a continuously variable transmission), for example, an insulated wire including a conductor and an insulator provided on the outer circumference of the conductor by extrusion covering, in which the conductor has been subjected to Ni plating or Ni alloy plating and the insulator is composed of a resin composition containing at least a sulfonyl group-containing resin having a sulfonyl group in a repeating unit, is publicly known (refer to Patent Document 1 JP-A-2015-141820).

### SUMMARY

An automatic transmission or a continuously variable transmission has no sufficient space therein for routing an insulated wire. Accordingly, reduction in diameter of the insulated wire to be routed in the automatic transmission or the continuously variable transmission has been demanded. However, the cross-sectional area of the insulated wire actually in use is 0.5 mm² or more. It is expected that further reduction in diameter of an insulated wire will be required with an increase of the number of circuits in a wire harness in the future.

Inside of the automatic transmission or the continuously variable transmission, AT fluid or CVT fluid is shaken by vibration and/or harshness of a running vehicle, so that the liquid level of the fluid fluctuates vertically. In addition, the AT fluid or the CVT fluid is circulated in the automatic transmission or the continuously variable transmission, so that the liquid level of the fluid fluctuates vertically. As the reduction in diameter of an insulated wire to be routed in the automatic transmission or the continuously variable transmission is developed, the rigidity of the insulated wire is reduced. Consequently, the insulated wire immersed in the AT fluid or the CVT fluid is more likely to be shaken by the fluctuation of the liquid level of the fluid. As a result, the insulated wire is bent in the automatic transmission or the continuously variable transmission, so that the fatigue of the insulated wire easily proceeds.

In order to avoid the aforementioned problem, it is conceivable to route the insulated wire in a manner so as not to be shaken by the AT fluid or the CVT fluid when routing the insulated wire in the automatic transmission or the continuously variable transmission. As a routing measure, it is conceivable, for example, to dispose the insulated wire in a manner so as not to be in contact with the AT fluid or the CVT fluid or to increase the number of a fixing position for the insulated wire. However, such measure is not desirable because it limits the flexibility in routing path and/or routing form.

The present configuration has been made in view of this background, and it is intended to provide an insulated wire in which fatigue of the insulated wire can be restrained even when the insulated wire is routed in the automatic transmission or the continuously variable transmission, and is shaken by AT fluid or CVT fluid.

One aspect of the present application provides an insulated wire including a conductor and an insulator that covers an outer circumference of the conductor, wherein

the conductor has a cross-sectional area of 0.4 mm² or less,

the insulator contains a polymer having S or F in a main chain, and has a thickness of 0.05 mm or more, and

the insulated wire has a density of 3.1 g/cm³ or more.

The insulated wire has a specific configuration as described above. According to such a configuration, fatigue of the insulated wire can be restrained even when the insulated wire is reduced in diameter, routed in an automatic transmission or a continuously variable transmission, and shaken by AT fluid or CVT fluid. Further, in the insulated wire, the insulator is hardly damaged by high-temperature AT fluid or high-temperature CVT fluid in the automatic transmission or the continuously variable transmission, and excels in high-temperature fluid resistance. Also, in the insulated wire, an insulation breakdown hardly occurs in a spark test.

### BRIEF DESCRIPTION OF THE DRAWINGS

FIG. 1 is a cross-sectional view of an insulated wire according to Embodiment 1.

FIG. 2 is a cross-sectional view showing a modified example of the insulated wire according to Embodiment 1.

### MODE FOR CARRYING OUT THE INVENTION

In the aforementioned insulated wire, the cross-sectional area of the conductor is 0.4 mm² or less. If the cross-sectional area of the conductor exceeds 0.4 mm², it is not possible to respond to a demand for reduction in diameter of the insulated wire in accompany with increase of the number of circuits in a wire harness. From the viewpoint of surely reducing the diameter of the insulated wire, the cross-sectional area of the conductor may be set preferably to 0.3 mm² or less, more preferably to 0.25 mm² or less, furthermore preferably to 0.2 mm² or less, and still furthermore preferably to 0.18 mm² or less. From the viewpoint of ensuring a current-carrying capacity suitable for use in an automobile, and to maintain a handleability in machining a wire harness, the cross-sectional area of the conductor may be set preferably to 0.01 mm² or more, more preferably to 0.03 mm² or more, and furthermore preferably to 0.05 mm² or more.

The conductor may be composed of a single metal element wire or a plurality of the metal element wires. When the plurality of the metal element wires is utilized, the conductor can be configured to have the plurality of the metal element wires that are twisted together. The conductor may have a circular contour when viewed in its cross section. Such a circular contour can be formed by circularly compressing the conductor in its radial direction. In addition, the conductor may have an uneven surface along the contour of the metal element wires. From the viewpoint of, for example, reducing the diameter of the insulated wire, the appearance of the insulated wire, etc., the conductor preferably has a circular contour when viewed in its cross section.

As a material for the conductor, Cu, a Cu alloy, Al, an Al alloy and the like can be exemplified. From the viewpoint of, for example, enhancing high-temperature fluid resistance, the conductor can have a plating layer composed of, for example, Ni plating, Ni alloy plating, or the like on its surface.

In the insulated wire, the insulator contains a polymer having S or F in a main chain. According to such a configuration, the insulator is hardly damaged by high-temperature AT fluid or high-temperature CVT fluid in the automatic transmission or continuously variable transmission, and the insulated wire that excels in high-temperature fluid resistance can be obtained.

The insulator may contain a polymer having S in a main chain, or may contain a polymer having F in a main chain. From the viewpoint of, for example, easily exhibiting high-temperature fluid resistance and easily ensuring the density of the insulated wire, the insulator preferably contains the polymer having F in a main chain.

Specific examples of the polymer having S in a main chain include, for example, a polyphenylene sulfide (PPS), a polysulfone resin, and the like. As the polysulfone resin, a polysulfone (PSU), a polyethersulfone (PES), a polyphenylsulfone (PPSU), and the like can be exemplified. These can be used singly or in combination of two or more. Specific examples of the polymer having F in a main chain include, for example, a fluororesin, a fluororubber (including an elastomer), and the like. These can be used singly or in combination of two or more. As the fluororesin resin, an ethylene-tetrafluoroethylene copolymer (ETFE), a polytetrafluoroethylene (PTFE), a tetrafluoroethylene-perfluoroalkylvinylether copolymer (PFA), a tetrafluoroethylene-hexafluoropropylene copolymer (FEP), a vinylidene fluoride resin (PVDF), and the like can be exemplified. These can be used singly or in combination of two or more. As the fluororubber, a vinylidene fluoride-based rubber (FKM), a tetrafluoroethylene-propylene rubber (FEPM), a tetrafluoroethylene-perfluoromethyl vinyl ether rubber (FFKM), and the like can be exemplified. These can be used singly or in combination of two or more.

The insulator may be configured to contain a resin of which the melting point is 200° C. or higher. In this case, the abrasion resistance of the insulator is increased by the resin of which the melting point is 200° C. or higher. Thus, the insulated wire that excels in abrasion resistance can be obtained. From the viewpoint of, for example, increasing the abrasion resistance, the melting point can be set preferably to 250° C. or higher, more preferably to 275° C. or higher, furthermore preferably to 300° C. or higher. As the resin of which the melting point is 200° C. or higher, for example, a resin that has F in a main chain, the melting point of which is 200° C. or higher, can be exemplified. As the resin that has F in a main chain, the melting point of which is 200° C. or higher, for example, ETFE (melting point: 270° C.), PTFE (melting point: 327° C.), PFA (melting point: 310° C.), and FEP (melting point: 260° C.) can be more specifically exemplified. These can be used singly or in combination of two or more. As the resin that has S in a main chain, the melting point of which is 200° C. or higher, for example, PPS (melting point: 278° C.) can be more specifically exemplified. This can be used singly or in combination of two or more kinds of different grades of the same each having a different molecular weight.

The insulator may contain one, or two or more kinds of various additives to be ordinarily used for an insulator in an insulated wire, in addition to the resin having S or F in a main chain. As the additives, for example, fillers, flame retardants, antioxidants, deterioration inhibitors, lubricants, plasticizers, copper damage inhibitors, pigments can be exemplified.

In the insulated wire, the thickness of the insulator is 0.05 mm or more. If the thickness of the insulator is made less than 0.05 mm, an insulation breakdown occurs when a spark test (applied voltage: 3 kV (rms)) is performed in conformity with JASO D 618: 2008. And, it becomes difficult to use it as an insulated wire. From the viewpoint of, for example, inhibiting the insulation breakdown, the thickness of the insulator can be set preferably to 0.07 mm or more, more preferably to 0.1 mm or more, and furthermore preferably to 0.15 mm or more. From the viewpoint of, for example, facilitating reduction in diameter of the insulated wire and ensuring the density of the insulated wire, the thickness of the insulator can be set preferably to 0.35 mm or less, more preferably to 0.33 mm or less, and furthermore preferably to 0.3 mm or less.

In the insulated wire, the density of the insulator can be set to 1.5 g/cm³ or more. In this case, it becomes easy to set the density of the insulated wire to 3.1 g/cm³ or more. The density of the insulator is a value to be calculated from the mass (g) of the insulator/the volume of the insulator (cm³). From the viewpoint of, for example, easily ensuring the density of the insulated wire, the density of the insulator can be set preferably to 1.55 g/cm³ or more, more preferably to 1.6 g/cm³ or more, furthermore preferably to 1.65 g/cm³ or more, and still furthermore preferably to 1.7 g/cm³ or more. Here, the density of the insulator can be set, for example, to 2.5 g/cm³ or less from the viewpoint of its availability.

In the insulated wire, the density of the insulated wire is 3.1 g/cm³ or more. The density of the insulated wire is an index related to the fatigue of the insulated wire which will be caused when the insulated wire having a reduced diameter is routed in the automatic transmission or the continuously variable transmission and is shaken by the AT fluid or the CVT fluid.

Specifically, an insulated wire is immersed in AT fluid or CVT fluid (hereinafter referred to simply as a fluid in some cases), the insulated wire is subject to the buoyancy of the fluid. The buoyancy F_{b} is expressed by Equation 1 as below, in which the density of the fluid is defined as pf, the volume of the part of the insulated wire immersed in the fluid is defined as V, and the gravitational acceleration is defined as g.

F_{b}=ρ_{f}×V×g Equation 1

As the buoyancy against the insulated wire becomes larger, the insulated wire is shaken more strongly by the fluctuation of the fluid liquid level, and thus, the fatigue of the insulated wire progresses. The insulated wire receives gravity that is proportional to the density of the insulated wire. The larger gravity more effectively cancels the influence of the buoyancy, and thus, the degree to which the insulated wire is shaken by the fluid is lowered. Consequently, the fatigue of the insulated wire tends not to occur. The gravity F acting on the insulated wire is expressed by Equation 2 as below, in which the density of the insulated wire is defined as ρₛ, the volume of the part of the insulated wire immersed in the fluid is defined as V, and the gravitational acceleration is defined as g.

F=ρₛ×V×g Equation 2

Based on Equations 1 and 2, the ratio F/F_{b} between the gravity F acting on the insulated wire and the buoyancy F_{b} acting on the insulated wire immersed in the fluid is expressed by Equation 3 as below.

F/F_{b}=ρₛ/ρ_{f} Equation 3

The larger the ratio is, the less the fluctuation of the fluid liquid level influences to the fatigue of the insulated wire. The densities of the AT and CVT fluids can be considered to be equivalent and fixed. Accordingly, if the density of the insulated wire ρₛ is determined, it becomes possible to restrain the fatigue of the insulated wire even when the insulated wire is shaken by the fluid. As shown in experimental examples to be described later, if the density of the insulated wire ρₛ is 3.1 g/cm³ or more, it is possible achieve the effects of restraining the fatigue of the insulated wire. On the other hand, if the density ρₛ of the insulated wire is less than 3.1 g/cm³, the insulated wire is easily shaken by the fluid. Consequently, it becomes difficult to restrain the fatigue of the insulated wire. From the viewpoint of reducing shake of the insulated wire to be caused by the fluid, it is preferable that the density ρₛ of the insulated wire be larger. However, an excessively large density ρₛ of the insulated wire prevents weight reduction of a wire harness. Therefore, the density ρₛ of the insulated wire can be set preferably to 8 g/cm³ or less, more preferably to 7.5 g/cm³ or less, and furthermore preferably to 7 g/cm³ or less. Here, the density ρₛ of the insulated wire is a value calculated from the mass (g) per one meter of the insulated wire/the volume (cm³) per one meter of the insulated wire.

It is noted that each configuration as described above can be combined as appropriate if necessary in order to obtain each operational effect and the like as described above.

Hereinafter, an insulated wire of an embodiment will be described with reference to the drawings.

### Embodiment 1

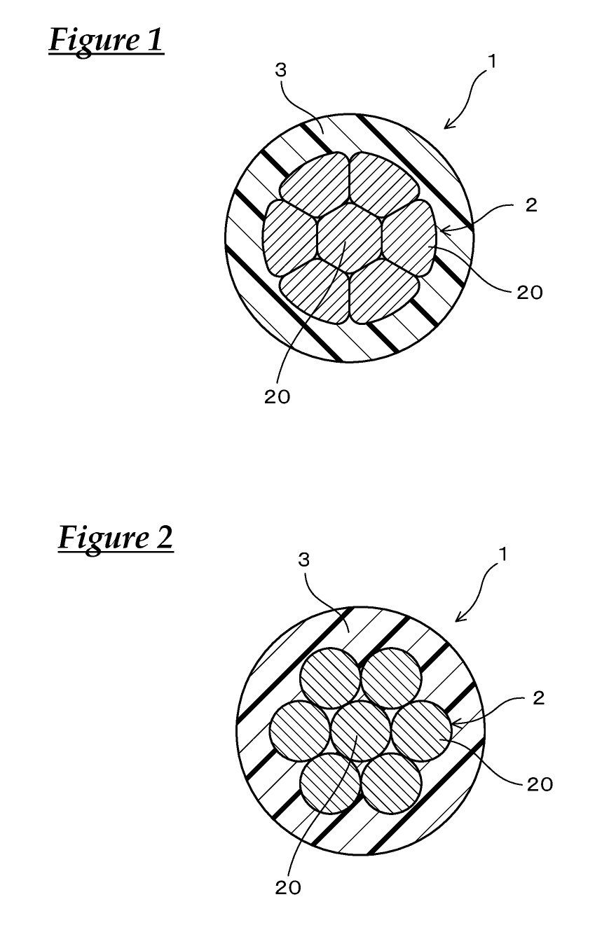

An insulated wire of Embodiment 1 will be described with reference to FIG. 1. As shown in FIG. 1, an insulated wire 1 of the present embodiment includes a conductor 2 and an insulator 3 that covers an outer circumference of the conductor 2. The cross-sectional area of the conductor 2 is 0.4 mm² or less. The insulator 3 contains a polymer having S or F in a main chain, and has a thickness of 0.05 mm or more. The density of the insulated wire is 3.1 g/cm³ or more.

In the present embodiment, the density of the insulator 3 is 1.5 g/cm³ or more. The insulator 3 is composed of a polysulfone resin as a polymer having S in a main chain, or a fluororesin or a fluororubber as a polymer having F in a main chain. The insulated wire 1 is used in a state of being immersed in AT fluid or CVT fluid.

The conductor 2 is composed of a plurality of metal element wires 20 that are twisted together. In FIG. 1, an example of the insulated wire, in which the conductor 2 has a circular contour by circularly compressing the plurality of metal element wires 20 that has been twisted together, is shown. Here, it is not necessary that the conductor 2 be circularly compressed as shown in FIG. 2.

### Experimental Examples

Hereinafter, the present configuration will be described more specifically using experimental examples.

### <Preparation of Insulated Wire>

Nine annealed copper wires each having a diameter of 0.15 mm were twisted together, and circularly compressed to prepare a conductor having a cross-section area of 0.16 mm². In the similar way, nineteen annealed copper wires each having a diameter of 0.13 mm were twisted together to prepare a conductor having a cross-section area of 0.24 mm². Nineteen annealed copper wires each having a diameter of 0.16 mm were twisted together to prepare a conductor having a cross-section area of 0.38 mm².

Each sample insulated wire was prepared by covering the outer circumference of the conductor having an predetermined cross-sectional area shown in Table 1 to be described later with a material for an insulator so as to have a predetermined thickness (a center value) by extrusion covering. In each insulated wire, the weight (g/m), outer diameter (mm) and density (g/cm³) of the insulated wire, the density of the insulator (g/cm³), the gravity acting on the insulated wire (N/m), the buoyancy in a fluid (N/m), and the ratio of the gravity to the buoyancy were measured or determined. In these experimental examples, AT fluid (ATF) having a density of 0.85 (g/cm³) was used.

### (Fatigue Resistance of Insulated Wire in Fluid)

In these experimental examples, the value of weight/buoyancy, i.e. the ratio of the gravity acting on each insulated wire to the buoyancy of the insulated wire in the fluid is used as an index of fatigue of the insulated wire in a state of being routed in the automatic transmission or the continuously variable transmission. Cases, in which the ratio of weight/buoyancy is 3.65 or higher was determined to have an ability to restrain the fatigue of the insulated wire even when the insulated wire would be shaken by the fluid, and was accepted. Cases, in which the ratio of weight/buoyancy is less than 3.65 was determined to have no ability to restrain the fatigue of the insulated wire when the insulated wire would be shaken by the fluid, and was rejected.

### (High-Temperature Fluid Resistance)

Each insulated wire was subjected to a fluid resistance test using the aforementioned AT fluid in conformity with JASO D618: (2008). Here, the test temperature of the AT fluid was set to 160° C. The insulated wires that had been accepted in the fluid resistance test were evaluated as excelling in high-temperature fluid resistance. The insulated wire that had been rejected in the fluid resistance test was evaluated as having no high-temperature fluid resistance.

### (Spark Test)

Each insulated wire was subjected to a spark test (applied voltage: 3 kV (rms)) in conformity with JASO D618: (2008). Cases, in which no insulation breakdown had occurred was accepted. Cases, in which an insulation breakdown had occurred was rejected.

Table 1 shows the configuration and evaluation result of each insulated wire all together.

TABLE 1

| | Sample 1 | Sample 2 | Sample 3 | Sample 4 | Sample 1C | Sample 2C | Sample 3C | Sample 4C |
|---|---|---|---|---|---|---|---|---|
| Cross-Sectional Area | 0.16 | 0.16 | 0.16 | 0.16 | 0.38 | 0.24 | 0.16 | 0.16 |
| of Conductor (mm²) | | | | | | | | |
| Polymer | ETFE | ETFE | PPS | ETFE | Fluororubber | ETFE | Polypropylene | ETFE |
| Constituting Insulator | | | | | | | | |
| Thickness of | 0.25 | 0.29 | 0.25 | 0.07 | 0.45 | 0.4 | 0.2 | 0.03 |
| Insulator (mm) | | | | | | | | |
| Weight of Insulated | 2.41 | 2.63 | 2.22 | 1.63 | 6.99 | 2.63 | 1.91 | 1.50 |
| Wire (g/m) | | | | | | | | |
| Outer Diameter of | 0.95 | 1.03 | 0.95 | 0.59 | 1.70 | 1.35 | 0.95 | 0.51 |
| Insulated Wire (mm) | | | | | | | | |
| Density of Insulated | 3.40 | 3.16 | 3.13 | 5.95 | 3.08 | 2.98 | 3.37 | 7.35 |
| Wire (g/cm³) | | | | | | | | |
| Density of | 1.8 | 1.8 | 1.45 | 1.8 | 1.9 | 1.8 | 1.2 | 1.8 |
| Insulator (g/cm³) | | | | | | | | |
| Gravity Acting on | 2.4 × 10⁻² | 2.6 × 10⁻² | 2.2 × 10⁻² | 1.6 × 10⁻² | 6.9 × 10⁻² | 2.6 × 10⁻² | 1.9 × 10⁻² | 1.5 × 10⁻² |
| Insulated | | | | | | | | |
| Wire (N/m) | | | | | | | | |
| Buoyancy in | 5.9 × 10⁻³ | 6.9 × 10⁻³ | 5.9 × 10⁻³ | 2.3 × 10⁻³ | 1.9 × 10⁻² | 1.2 × 10⁻² | 4.7 × 10⁻³ | 1.7 × 10⁻³ |
| Fluid (N/m) | | | | | | | | |
| Gravity/Buoyancy | 4.07 | 3.77 | 3.73 | 6.96 | 3.63 | 2.17 | 4.04 | 8.82 |
| Fatigue Resistance of | Accepted | Accepted | Accepted | Accepted | Rejected | Rejected | Accepted | Accepted |
| Insulated Wire in Fluid | | | | | | | | |
| High-temperature | Accepted | Accepted | Accepted | Accepted | Accepted | Accepted | Rejected | Accepted |
| Fluid Resistance | | | | | | | | |
| Spark Test | Accepted | Accepted | Accepted | Accepted | Accepted | Accepted | Accepted | Rejected |

Table 1 shows the followings. The insulated wires of Samples 1C and 2C have a density of less than 3.1 g/cm³. Accordingly, in the insulated wires of Samples 1C and 2C, the ratio of weight/buoyancy fell down the specified value, and thus the fatigue resistance in the fluid was poor.

In the insulated wire of Sample 3C, the insulator is composed of a polypropylene, namely, the insulator is not composed of a polymer having S or F in a main chain. Accordingly, in the insulated wire of Sample 3C, the insulator was damaged by high-temperature AT fluid, and thus the high-temperature fluid resistance was poor.

In the insulated wire of Sample 4C, the thickness of the insulator is less than 0.05 mm. Accordingly, in the insulated wire of Sample 4C, an insulation breakdown occurred in the spark test.

In contrast, the insulated wires of Samples 1 to 4 have specified configurations as described above. Accordingly, it can be said that the fatigue can be restrained in the insulated wires of Samples 1 to 4 even when the insulated wires of Samples 1 to 4 are reduced in diameter, routed in the automatic transmission or the continuously variable transmission, and shaken by the AT or CVT fluid. Further, it can be said that the insulators in the insulated wires of Samples 1 to 4 are hardly damaged by the high temperature AT fluid or CVT fluid in the automatic transmission or the continuously variable transmission, and excel in high-temperature fluid resistance. Furthermore, it can be said that the insulated wires of Samples 1 to 4 hardly suffer an insulation breakdown in the spark test.

Although embodiments of the present configuration were described in detail above, the present invention is not limited to the aforementioned embodiments and experimental examples, and various modifications are possible within a range that does not deviate from the gist of the present invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An insulated wire comprising a conductor and an insulator that covers an outer circumference of the conductor, wherein
the conductor has a cross-sectional area of 0.4 mm² or less,
the insulator contains a polymer having S or F in a main chain, and has a thickness of 0.05 mm or more, and
the insulated wire has a density of 3.1 g/cm³ or more.

2. The insulated wire according to claim 1, wherein the insulator has a density of 1.5 g/cm³ or more.

3. The insulated wire according to claim 1, wherein the insulator contains a resin of which a melting point is 200° C. or higher.

4. The insulated wire according to claim 2, wherein the insulator contains a resin of which a melting point is 200° C. or higher.

5. The insulated wire according to claim 1, wherein the thickness of the insulator is 0.35 mm or less.

6. The insulated wire according to claim 4, wherein the thickness of the insulator is 0.35 mm or less.

7. The insulated wire according to claim 1, wherein the density of the insulated wire is 8 g/cm³ or less.

8. The insulated wire according to claim 6, wherein the density of the insulated wire is 8 g/cm³ or less.

9. The insulated wire according to claim 2, wherein the density of the insulator is 2.5 g/cm³ or less.

10. The insulated wire according to claim 8, wherein the density of the insulator is 2.5 g/cm³ or less.

11. The insulated wire according to claim 1, wherein the insulator contains a polymer having F in a main chain, and the polymer having F in a main chain is at least one of a fluororesin and a fluororubber.

12. The insulated wire according to claim 10, wherein the insulator contains a polymer having F in a main chain, and the polymer having F in a main chain is at least one of a fluororesin and a fluororubber.

13. The insulated wire according to claim 11, wherein the fluororesin is at least one selected from the group consisting of an ethylene-tetrafluoroethylene copolymer, a polytetrafluoroethylene, a tetrafluoroethylene-perfluoroalkylvinylether copolymer, a tetrafluoroethylene-hexafluoropropylene copolymer, and a vinylidene fluoride resin.

14. The insulated wire according to claim 12, wherein the fluororesin is at least one selected from the group consisting of an ethylene-tetrafluoroethylene copolymer, a polytetrafluoroethylene, a tetrafluoroethylene-perfluoroalkylvinylether copolymer, a tetrafluoroethylene-hexafluoropropylene copolymer, and a vinylidene fluoride resin.

15. The insulated wire according to claim 11, wherein the fluororubber is at least one selected from the group consisting of a vinylidene fluoride-based rubber, a tetrafluoroethylene-propylene rubber, and a tetrafluoroethylene-perfluoromethyl vinyl ether rubber.

16. The insulated wire according to claim 12, wherein the fluororubber is at least one selected from the group consisting of a vinylidene fluoride-based rubber, a tetrafluoroethylene-propylene rubber, and a tetrafluoroethylene-perfluoromethyl vinyl ether rubber.

17. The insulated wire according to claim 1, wherein the insulator contains a polymer having S in a main chain, and the polymer having S in a main chain is at least one of a polyphenylene sulfide, a polysulfone, a polyethersulfone, and a polyphenylsulfone.

18. The insulated wire according to claim 10, wherein the insulator contains a polymer having S in a main chain, and the polymer having S in a main chain is at least one of a polyphenylene sulfide, a polysulfone, a polyethersulfone, and a polyphenylsulfone.

19. The insulated wire according to claim 1, wherein the insulated wire is configured to be used in a state of being immersed in AT fluid or CVT fluid.

20. The insulated wire according to claim 12, wherein the insulated wire is configured to be used in a state of being immersed in AT fluid or CVT fluid.
